(19) United States
(12) Patent Application Publication
(10) Pub. No.: US 2007/0286420 A1
(43) Pub. Date: Dec. 13, 2007

(54) ENCRYPTION OF VIDEO CONTENT TO VOD SERVICES AND NETWORKED PERSONAL VIDEO RECORDERS USING UNIQUE KEY PLACEMENTS

(75) Inventors: Charles Duncan MacLean, Claremont, CA (US); Edward Charles Hiar, Lynnwood, WA (US); Hamid Shaheed Ali, Edmonds, WA (US); Sergio Jose Goncalves da Silva, Carris (PT); Andre Jacobs, Redmond, WA (US); Edward H. Schacker, Everett, WA (US)

Correspondence Address: DARBY & DARBY P.C., P.O. BOX 770, Church Street Station, New York, NY, 10008-0770, US

(73) Assignee: Widevine Technologies, Inc., Seattle, WA (US)

(21) Appl. No.: 11/748,341

(22) Filed: May 14, 2007

Related U.S. Application Data
(60) Provisional application No. 60/804,268, filed on Jun. 8, 2006.

(51) Int. Cl. H04N 7/167

(52) U.S. Cl. 380/201; 380/239; 380/203

(57) ABSTRACT

A network device and method are directed towards providing one time content encryption for Video on Demand (VOD) broadcast services and Networked Personal Video Recorders (NPVRs) using unique encryption keys. As content is received by the network device, it is determined whether the content is for broadcast distribution to a consumer and to be ingested into an NPVR/VOD server for possible unicast distribution. If the content is for both distributions, it is encrypted using at least one control word (CW) key. The encrypted content is then copied into at least two streams, with the CW being encrypted with at least two different keys, one for broadcast distribution, and one for NPVR Programs. One stream may then be ingested by the NPVR/VOD server, while the other stream may be broadcast to a consumer. The encryption keys may be provided through EMMs to a consumer based on a purchase.

### CROSS-REFERENCE

This utility patent application claims priority to U.S. Provisional Patent Application No. 60/804,268, filed on Jun. 8, 2006, the benefit of which is claimed under 35 U.S.C. §119, and which is further incorporated herein by reference.

### BACKGROUND

The present invention relates generally to digital copy protection, digital rights management, and conditional access, and more particularly but not exclusively to providing one time content encryption for traditional broadcast services, pay per view (PPV) broadcast services and Networked Personal Video Recorder (NPVR) Programs using unique encryption keys.

Personal Video Recorders (PVRs) are digital devices that are configured to record and play video or other digital content to or from a digital storage medium, such as a hard drive, memory card, or the like. Such devices, are well known today, and may include set top boxes (STBs), personal computers, and so forth. TiVo, ReplayTV, MythTV, and SageTV are examples of PVRs and/or software for PVRs.

Many of today's PVRs allow the consumer of the digital content to record the digital content, skip portions of the digital content such as commercials, perform instant replay of a portion of the digital content, pause the digital content, schedule recordings of broadcast services, and share the recorded digital content over a network.

PVRs provide many features that are desired by the consumer, many of these PVRs lack sufficient storage capacity for at least some consumers. Partially, in response to this deficiency, companies have started to provide a product known as a Network PVR (NPVR). NPVRs provide similar functionality to PVRs except that the recorded digital content may be stored on a network device that is remote from the consumer.

In many operator deployments, first generation standard Internet Protocol TeleVision (IPTV) STBs have been deployed. It is desirable for these operators to offer NPVR functionality on these STBs. The offer of the NPVR functionality on a standard IPTV STB also provides another revenue generating model for these deployments.

As the popularity of NPVRs increase, many companies seek approaches to their business model that allows consumers to purchase particular digital content, rather than say based on a monthly subscription to a broadcast of digital content, as well as being able to provide the monthly subscriptions to digital content. Providing various ways of obtaining digital content may also include providing protections to limit unscrupulous consumers from obtaining digital content improperly. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating an environment for practicing the invention;

FIG. 2 shows one embodiment of a network device that may be employed as a distribution service;

FIG. 3 shows one embodiment of a client device that may be employed to receive and play secure content; and

FIG. 4 illustrates a flow diagram generally showing one embodiment for a process of generating secure content concurrently for VOD broadcast services and NPVR services using unique keys, in accordance with the invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein;

rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

“Conditional access” or “digital rights management” refers to a mechanism that enables a provider to restrict access of selected content to selected consumers. This may be achieved, for example by encrypting the content. One such encryption approach employs a technique that provides a message known as an Entitlement Control Message (ECM). The ECM is typically a packet of data which includes information to determine a control word (CW) for use in decrypting at least a section of the content. In this approach, a stream or file based content may be encrypted using several CWs. Each CW may be encrypted with a service key and encapsulated in an ECM message. The encrypted content, including the ECMs may then be provided to a consumer.

The service key may also be encrypted using an encryption key that may be specific to a consumer, and sent to the consumer within a message frame, packet, or the like. For example, the encrypted service key may be sent within an Entitlement Management Message (EMM). The EMM may also include additional information such as subscription information associated with a consumer, entitlement information, or the like. In one embodiment, the consumer's encryption key used to encrypt the service key may be unique to a consumer's playback device, such as their PVR, STB, computer, or the like.

As used herein, the term “entitlement” refers to a right to access and use content.

Typically, an entitlement may include a constraint on when the content may be accessed, how long it may be accessed, how often the content may be accessed, whether the content may be distributed, reproduced, modified, sold, or the like. In some instances, an entitlement may restrict where the content may be accessed as well.

In one embodiment, the content is provided as a Moving Pictures Experts Group (MPEG) content stream, such as a transport stream, or the like. However, the invention is not so limited, and other file formats may also be employed, without departing from the scope or spirit of the invention. For example, in one embodiment, the content may be provided using other file formats such as Windows Media, QT, Real, and/or Adobe Flash video file formats, or the like.

Briefly, however, MPEG is an encoding and compression standard for digital broadcast content. MPEG provides compression support for television quality transmission of video broadcast content. Moreover, MPEG provides for compressed audio, control, and even consumer broadcast content. One embodiment of MPEG-2 standards is described in ISO/IEC 13818-7, which is hereby incorporated by reference.

MPEG content streams may include Packetized Elementary Streams (PES), which typically include fixed (or variable sized) blocks or frames of an integral number of elementary streams (ES) access units. An ES typically is a basic component of an MPEG content stream, and includes digital control data, digital audio, digital video, and other digital content (synchronous or asynchronous). A group of tightly coupled PES packets referenced to substantially the same time base comprises an MPEG program stream (PS). Each PES packet also may be broken into fixed-sized transport packet known as MPEG Transport Streams (TS) that form a general-purpose approach of combining one or more content streams, possibly including independent time bases. Moreover, MPEG frames may include intra-frames (I-frames), forward predicted frames (P-frames), and/or bi-directional predicted frames (B-frames).

Briefly, the present invention is directed towards a method, apparatus, and system for providing one time content encryption for broadcast services and Networked Personal Video Recorders (NPVRs) using unique service or NPVR Program encryption keys. As content is received by the network broadcast encryption device, it is determined whether the content is for broadcast distribution to a consumer and to be ingested into an NPVR/VOD server for possible unicast distribution. If the content is for both distributions, it is encrypted using at least one CW key. The encrypted content is then duplicated (e.g., copied) into at least two streams, with the CW being encrypted with at least two different keys, one for broadcast distribution and one for NPVR Programs. One stream may then be ingested by the NPVR/VOD server, while the other stream may be broadcast to a consumer client device. The unique broadcast service key may be provided through an ECM to a consumer based on a subscription, or the like. Similarly, the unique NPVR Program key may be provided through the NPVR/VOD server to a consumer based upon a purchase. Employing the present invention is directed towards enabling differentiation of entitlements between the broadcast copy and the NVPR copy without incurring additional costs of multiple encryptions of the content stream.

### Illustrative Environment

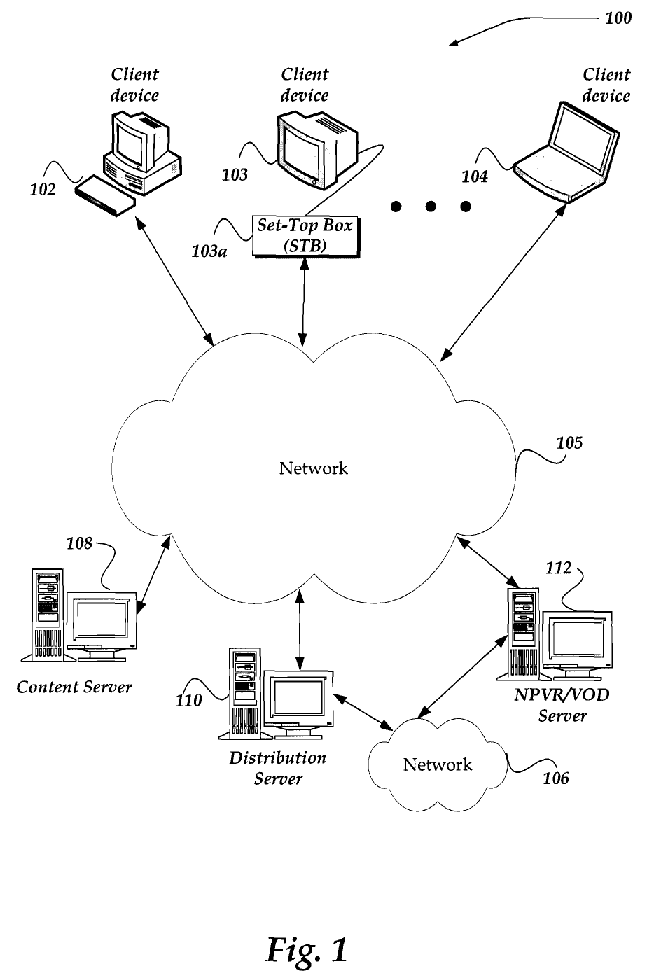

FIG. 1 is a functional block diagram illustrating an exemplary operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes client devices 102-104, networks 105-106, content server 108, distribution server 110, and Network Personal Video Recorder (NPVR)/VOD server 112. Client devices 102-104 are in communication with distribution server 110 and NPVR/VOD server 112 through network 105. Content server 108 is in communication with distribution server 110 through network 105, while distribution server 110 is in further communication with NPVR/VOD server 112 through networks 105-106.

Content server 108 includes virtually any network computing device that is configured to provide content to distribution server 110 over network 105. Content server 108 may represent services provided by producers, developers, and owners of media content that can be distributed to client devices 104. Such content includes but is not limited to motion pictures, movies, videos, VOD, interactive media, applications, and other forms of digital content useable by a computing device. In one embodiment, content includes special event media content such as boxing matches, sports events, theater events, musical events, weather reports, historical events, or the like. Content may, in one embodiment, represent pay per view (PPV) content, such as a subscription capable broadcast of a plurality of movies, or the like. However, content owned by content server 108 is not limited to video content only, and may include audio only services, without departing from the scope or spirit of the present invention. Thus, content is intended to include, but is not limited to, audio, video, still images, text, graphics, or the like.

In one embodiment, content server 108 may provide the content to distribution server 110 as a broadcast stream of content. In one embodiment, content server 108 may select to provide the content in the clear (e.g., not encrypted) as a multicast stream to a plurality of distribution servers, including distribution server 110. In another embodiment, content server 108 may select to provide at least a portion of the content as encrypted content. In one embodiment, content server 108 may provide the content as an MPEG stream.

Devices that may operate as content server 108 include, but are not limited to personal computers, desktop computers, multiprocessor systems, microprocessor-based or programmable consumer electronics, network PCs, servers, network appliances, and the like.

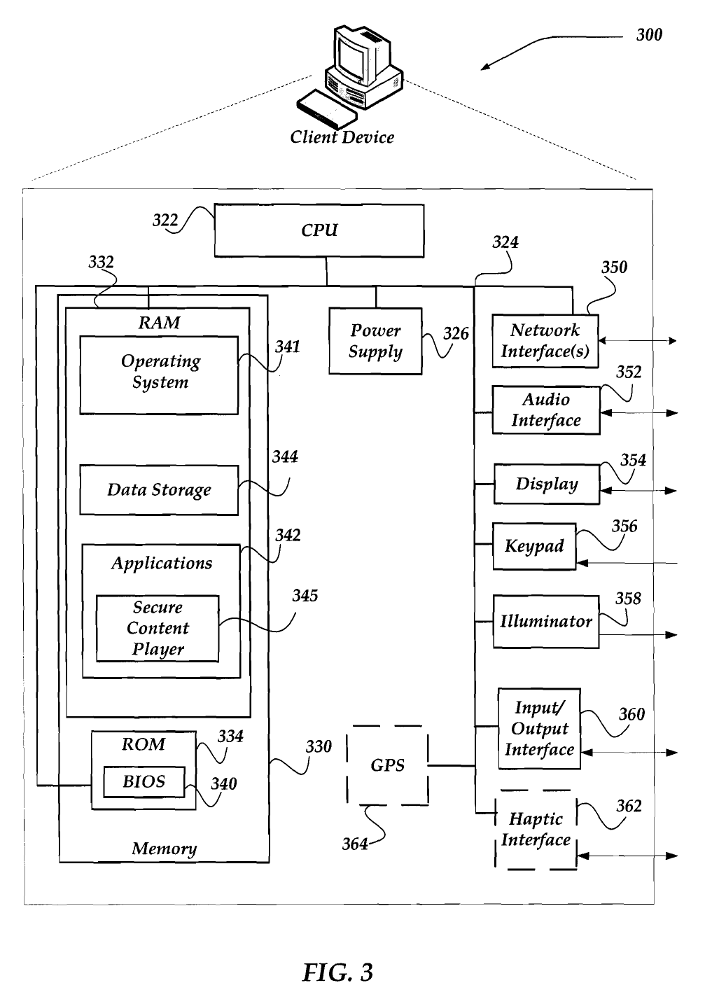

One embodiment of a possible client device is described in more detail below in conjunction with FIG. 3. Briefly, however, client devices 102-104 may include virtually any computing device capable of receiving content over a network, such as network 105, from another computing device, such as distribution server 110 and/or NPVR/VOD server 112. Client devices 102-104 may also include any computing device capable of receiving the content employing other mechanisms, including, but not limited to CDs, DVDs, tape, electronic memory devices, or the like. The set of such devices may include devices that typically connect using a wired communications medium such as personal computers, multiprocessor systems, microprocessor-based or programmable consumer electronics, network PCs, or the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or the like. Client devices 102-104 may also be any device that is capable of connecting using a wired or wireless communication medium such as a PDA, POCKET PC, wearable computer, and any other device that is equipped to communicate over a wired and/or wireless communication medium to receive and play content. Similarly, client devices 102-104 may employ any of a variety of devices to enjoy such content, including, but not limited to, a computer display system, an audio system, a jukebox, set top box (STB) (such as STB 103a), Personal Video Recorder (PVR), a television, video display device, or the like.

Client devices 102-104 may include a client that is configured to enable an end-user to receive content and to play the received content. The client may also provide other actions, including, but not limited to, enabling other components of the client device to execute, enable an interface with another component, device, the end-user, or the like.

Client devices 102-104 may receive the content as scrambled/encrypted and employ a conditional access control component to decrypt content, and/or enable revocation of an access entitlement and/or right associated with content. For example, client devices 102-104 may receive content decryption keys, service keys, entitlements and/or rights, or the like. Moreover, client devices 102-104 may employ a smart card, such as a virtual smart card, or the like, to manage access to and decryption of the content. In one embodiment, client devices 102-104 may employ a decryption key for decrypting service keys, or the like, where the decryption key is unique to the client device. For example, in one embodiment, at least a portion of the decryption key may be generated based on a characteristic of the client device, including, but not limited to a Central Processing Unit's (CPU's) kernel calculated speed, CPU serial number, CPU family identity, CPU manufacturer, an operating system globally unique identifier (GUID), hardware component enumerations, Internet Protocol (IP) address, BIOS serial number, disk serial number, kernel version number, operating system version number, operating system build number, machine name, installed memory characteristic, physical port enumeration, customer supplied ID, MAC address, and the like. Moreover, in one embodiment, the decryption key may be stored within the smart card.

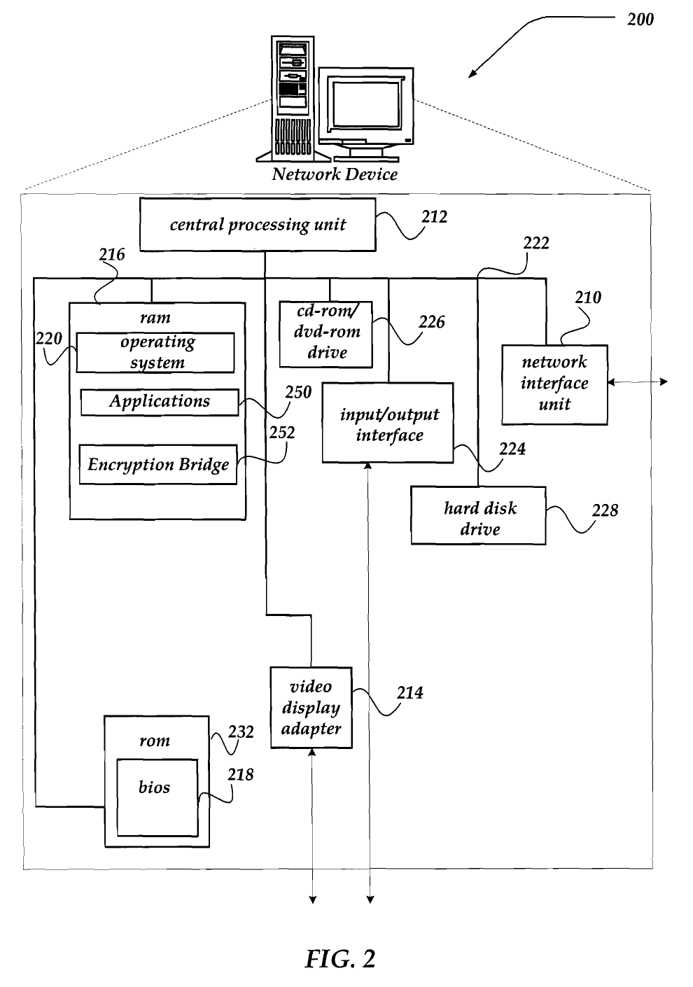

One embodiment of distribution server 110 is described in more detail below in conjunction with FIG. 2. Briefly, however, distribution server 10 includes virtually any network device configured for use by companies, businesses, systems, or the like that obtain rights from a content owner to copy and distribute the content. Distribution server 10 may obtain the rights to copy and distribute from one or more content owners. Distribution server 110 may repackage, store, and schedule content for subsequent sale, distribution, and license to other content providers, users of client devices 102-104, or the like. Distribution server 110 may also provide the content to a VOD server that may operate a NPVR service to store the content for requests from, for example, a client device.

As described further below, distribution server 110 may determine whether content is to be provided to client devices 102-105 and to NPVR/VOD server 112. Where the content is to be provided to both, distribution server 110 may selectively encrypt at least a portion of the content using at least one CW, and then copy the selectively encrypted content into at least two streams. At least one stream may include ECMs having the CWs encrypted with one service key, while at least another stream may include ECMs having the CWs encrypted with a different NPVR Program key.

Moreover, as described below, distribution server 10 may select any of a variety of mechanisms for replicating and distributing the replicated streams to their respective recipients.

Distribution server 110 may provide the content over network 105 to client devices 102-104, or the like. In one embodiment, distribution server 110 may also provide the content to NPVR/VOD 112 over network 105 and/or network 106. Distribution server 110 may provide the content using any of a variety of mechanisms. In one embodiment, the content is provided as a Moving Pictures Experts Group (MPEG) content stream, such as a transport stream, or the like. However, the invention is not so limited, and other file formats may also be employed, without departing from the scope or spirit of the invention. In one embodiment, distribution server 110 provides the content over network 105 as a broadcast stream.

Distribution server 110 may also enable scrambling and/or encryption of the content to minimize the likelihood of unauthorized consumers improperly enjoying the content. Distribution server 110 may also manage access control messages to determine whether descrambling and/or decrypting of the content is to be performed. In one embodiment, distribution server 110 may employ ECM and/or EMM messages to manage conditional access to the scrambled content. However, the invention is not so limited, and other forms of access control messages, or mechanisms, may also be employed without departing from the scope or spirit of the invention.

Distribution server 110 is not limited to providing content, and/or ECMs, and/or EMMs to client devices 102-104 over network 105, however. For example, distribution server 110 may also employ a variety of portable content storage devices, including, but not limited to Digital Versatile Discs (DVDs), High Definition DVD (HD-DVD), Compact Discs (CDs), Video Compact Disc (VCD), Super VCD (SVCD), Super Audio CD (SACD), Dynamic Digital Sound (DDS) content media, Read/Write DVD, CD-Recordable (CD-R), Blu-Ray discs, or the like. Moreover, distribution server 110 may provide content using, for example, a portable content storage device, while providing the ECMs, EMMs over network 105, without departing from the scope or spirit of the invention.

Devices that may operate as distribution server 110 include personal computers, desktop computers, multiprocessor systems, network appliance, microprocessor-based or programmable consumer electronics, network PCs, servers, network appliance, or the like.

Networks 105-106 are configured to couple one computing device to another computing device to enable them to communicate. Networks 105-106 are enabled to employ any form of computer readable media for communicating information from one electronic device to another. Also, networks 105-106 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, networks 105-106 include any communication method by which information may travel between computing devices.

Moreover, networks 105-106 may represent a plurality of different components, and/or network paths between network computing devices. Thus, content and/or other information provided by distribution server 110 to client devices 102-104 may employ at least in part a different network component and/or path than information provided by distribution server 110 to NPVR/VOD server 112, or even between content provider 108 and distribution server 110. For example, distribution server 110 may provide content, including ECMs, and/or EMMs to client devices 102-104 over a satellite link, while client devices 102-104 may provide information to distribution server 110 using a wired link, a telephone dial-up component, or the like. However, the invention is not so limited, and distribution server 110 and client devices 102-104 may also employ virtually the same network 105 components, protocols, and/or mechanisms with which to communicate information, and/or a variety of other paths, components, or the like.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wired media such as twisted pair, coaxial cable, fiber optics, wave guides, and other wired media and wireless media such as acoustic, RF, infrared, and other wireless media.

NPVR/VOD server 112 includes virtually any network device configured to operate as a networked digital video recording device to store content for use by client devices 102-104. Devices that may operate as NPVR/VOD server 112 include personal computers, desktop computers, multiprocessor systems, network appliance, microprocessor-based or programmable consumer electronics, network PCs, servers, or the like.

### Illustrative Server Environment

FIG. 2 shows one embodiment of a network device, according to one embodiment of the invention. Network device 200 may include many more or less components than those shown. For example, network device 200 may operate as a network appliance without a display screen. The components shown, however, are sufficient to disclose an illustrative embodiment for practicing the invention. Network device 200 may, for example, represent distribution server 110 of FIG. 1.

Network device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, via network interface unit 210, which is constructed for use with various communication protocols including the TCP/IP protocol. Network interface unit 210 is sometimes known as a transceiver, transceiving device, network interface card (NIC), or the like.

Network device 200 may also include an SMTP handler application for transmitting and receiving email. Network device 200 may also include an HTTP handler application for receiving and handing HTTP requests, and an HTTPS handler application for handling secure connections. The HTTPS handler application may initiate communication with an external application in a secure fashion.

Network device 200 also may include input/output interface 224 for communicating with external devices, such as a mouse, keyboard, scanner, or other input devices not shown in FIG. 2. Likewise, network device 200 may further include additional mass storage facilities such as CD-ROM/DVD-ROM drive 226 and hard disk drive 228. Hard disk drive 228 is utilized by network device 200 to store, among other things, application programs, databases, or the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, transcoders, database programs, word processing programs, spreadsheet programs, security programs, and so forth. Mass storage may further include applications such encryption bridge 252.

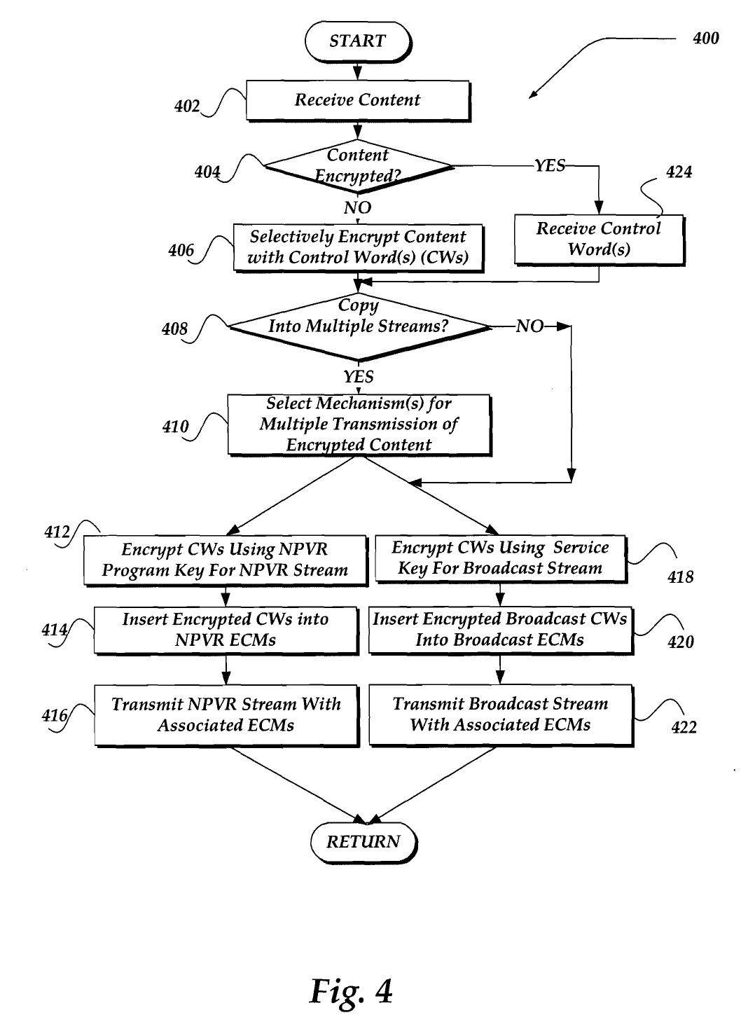

Encryption bridge 252 may employ a process such as described below in conjunction with FIG. 4 to perform at least some of its actions. Briefly, however, encryption bridge 252 is configured to receive content from a variety of sources. For example, in one embodiment, encryption bridge 252 may receive content from one or more upstream content providers. In one embodiment, the content is received as a multicast stream.

If the content is received unencrypted, encryption bridge 252 may scramble/encrypt the content using any of a variety of encryption mechanisms to generate encrypted content, including, but not limited, to RSA algorithms, Data Encryption Standard (DES), International Data Encryption Algorithm (IDEA), Skipjack, RC4, Advanced Encryption Standard (AES), Elliptic Curve Cryptography, or the like. Thus, encryption bridge 252 may employ any of a variety of public key (asymmetric key) algorithms, and/or symmetric key algorithms. Moreover, in one embodiment, for control keys (CWs), service keys, and/or NPVR Program keys encryption bridge 252 may vary which encryption mechanism is employed for a given content stream, for different content recipients, or the like.

Encryption bridge 252 may also selectively encrypt at least a portion of the content leaving another portion unencrypted (e.g., in the clear). Encryption bridge 252 may selectively encrypt one portion of the content using one encryption technique, and another portion of the content using a different encryption technique. Encryption bridge 252 may further employ different content encryption control keys (CWs) for different portions of the selectively encrypted content.

Encryption bridge 252 may select to encrypt a video elementary stream (ES), an audio ES, a digital data ES, and/or any combination, and/or any portion of video, audio, data elementary streams to generate encrypted content. Encryption bridge 252 may further select to encrypt at least a portion of an I-frame, P-frame, B-frame, and/or any combination of P, B, and I frames. Moreover encryption bridge 252 may perform such encryption on-the-fly.

Encryption bridge 252 may also employ a policy to monitor the received content. In one embodiment, the policy may be based on an Internet Protocol (IP) address, a type of content, a source of the content, or the like. In any event, if, based in part on the policy, the content is to be provided to an NPVR service (e.g., ingested by a VOD service for storage) and to be broadcast to one or more consumers, encryption bridge 252 may replicate (or copy) the encrypted content into two or more encrypted content streams.

Encryption bridge 252 may then employ distinct service keys for each of the plurality of copied content streams to encrypt different copies the CWs. Encryption bridge 252 may also place the encrypted CWs into ECMs, and/or the service keys within EMMs. The service keys may be further encrypted for example, using a recipient's unique encryption/decryption key. In one embodiment, the recipient's unique encryption/decryption key may be a symmetric key; however, the recipient's unique encryption/decryption key may also be configured based on a public/private (asymmetric) key pair, without departing from the scope of the invention. Encryption bridge 252 may employ MPEG or another mechanism to prepare the content, ECMs, and/or EMMs to a client device, NPVR/VOD server, or the like.

Encryption bridge 252 may provide the different selectively encrypted content streams, ECMS, and/or EMMs using differentiated network flows towards the recipient network device. For example, encryption bridge 252 may differentiate the content streams based on various layers of the Open Systems Interconnection (OSI) network protocol stack. For instance, at layer 1 of the OSI protocol, encryption bridge 252 may employ distinct NICs or separate technologies, such as providing one stream over 10Base-T, while another stream is broadcast to a recipient using 100Base-T, ATM, or the like. Similarly, differentiation of content streams toward the different recipients (e.g., NPVR/VOD server, client devices, or the like) may be achieved based in part on layer 2 of the OSI protocol. For example, different Ethernet devices, different VLANs, different source MAC addresses, ATM virtual channels, SDH channels, or the like, may be employed. At layer 3 of the OSI protocol, differentiation may be achieved by using different IP addresses, independent of a difference at layer 1 and/or layer 2. In addition, differentiation may also be achieved at layer 4, by providing the content streams over different TCP ports. It should be noted however, the invention is not limited to these examples, and other approaches to differentiate the streams may also be employed, without departing from the scope or spirit of the invention.

### Illustrative Mobile Client Environment

FIG. 3 shows one embodiment of client device 300 that may be included in a system implementing the invention. Client device 300 may include many more or less components than those shown in FIG. 3. However, the components shown are sufficient to disclose an illustrative embodiment for practicing the present invention. Client device 300 may represent, for example, client devices 102-104 of FIG. 1.

As shown in the figure, client device 300 includes a processing unit (CPU) 322 in communication with a mass memory 330 via a bus 324. Client device 300 also includes a power supply 326, one or more network interfaces 350, an audio interface 352, a display 354, a keypad 356, an illuminator 358, an input/output interface 360, optional haptic interface 362, and an optional global positioning systems (GPS) receiver 364. Power supply 326 provides power to client device 300. A rechargeable or non-rechargeable battery may be used to provide power. The power may also be provided by an external power source, such as an AC adapter or a powered docking cradle that supplements and/or recharges a battery.

Client device 300 may optionally communicate with a base station (not shown), or directly with another computing device. Network interface 350 includes circuitry for coupling client device 300 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 350 is sometimes known as a transceiver, transceiving device, or network interface card (NIC). In one embodiment, network interface 350, display 354, audio interface, and/or input/output interface 360 may be configured to communicate with a computer display system, an audio system, a jukebox, STB, PVR, a television, video display device, or the like. In one embodiment, network interface 350 may also enable communications with NPVR/VOD server 112 and/or distribution server 110 of FIG. 1, without departing from the scope of the invention.

Audio interface 352 is arranged to produce and receive audio signals such as the sound of a human voice. For example, audio interface 352 may be coupled to a speaker and microphone (not shown) to enable telecommunication with others and/or generate an audio acknowledgement for some action. Display 354 may be a liquid crystal display (LCD), gas plasma, light emitting diode (LED), or any other type of display used with a computing device. Display 354 may also include a touch sensitive screen arranged to receive input from an object such as a stylus or a digit from a human hand.

Keypad 356 may comprise any input device arranged to receive input from a user. For example, keypad 356 may include a push button numeric dial, or a keyboard. Keypad 356 may also include command buttons that are associated with selecting and sending images. Illuminator 358 may provide a status indication and/or provide light. Illuminator 358 may remain active for specific periods of time or in response to events. For example, when illuminator 358 is active, it may backlight the buttons on keypad 356 and stay on while the client device is powered. Also, illuminator 358 may backlight these buttons in various patterns when particular actions are performed, such as dialing another client device. Illuminator 358 may also cause light sources positioned within a transparent or translucent case of the client device to illuminate in response to actions.

Client device 300 also comprises input/output interface 360 for communicating with external devices, such as a headset, or other input or output devices not shown in FIG. 2. Input/output interface 360 can utilize one or more communication technologies, such as USB, infrared, Bluetooth™, or the like. Optional haptic interface 362 is arranged to provide tactile feedback to a user of the client device. For example, optional haptic interface may be employed to vibrate client device 300 in a particular way when another user of a computing device is calling.

Optional GPS transceiver 364 can determine the physical coordinates of client device 300 on the surface of the Earth, which typically outputs a location as latitude and longitude values. GPS transceiver 364 can also employ other geo-positioning mechanisms, including, but not limited to, triangulation, assisted GPS (AGPS), E-OTD, CI, SAI, ETA, BSS or the like, to further determine the physical location of client device 300 on the surface of the Earth. It is understood that under different conditions, GPS transceiver 364 can determine a physical location within millimeters for client device 300; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 330 includes a RAM 332, a ROM 334, and other storage means. Mass memory 330 illustrates another example of computer storage media for storage of information such as computer readable instructions, data structures, program modules or other data. Mass memory 330 stores a basic input/output system (“BIOS”) 340 for controlling low-level operation of client device 300. The mass memory also stores an operating system 341 for controlling the operation of client device 300. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 330 further includes one or more data storage 344, which can be utilized by client device 300 to store, among other things, applications 342 and/or other data. For example, data storage 344 may also be employed to store information that describes various capabilities of client device 300. The information may then be provided to another device based on any of a variety of events, including being sent as part of a header during a communication, sent upon request, or the like. Data storage 344 may also store information that uniquely identifies client device 300 including a phone number, a Mobile Identification Number (MIN), an electronic serial number (ESN), Mobile Station International ISDN Number (MSISDN), IP address, or other network identifier. Moreover, data storage 344 may also be employed to store entitlements in a variety of formats, including but not limited to an ECM, EMM, or the like. At least a portion of the stored entitlements may also be stored on a disk drive or other storage medium (not shown) within client device 300.

Applications 342 may include computer executable instructions which, when executed by client device 300, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 342 may further include secure content player 345.

Secure content player 345 is configured to enable of secure content such as a selectively encrypted broadcast stream and/or an NPVR stream. In one embodiment secure content player 345 may be configured to receive and employ ECMs, EMMs, or the like, to access one or more encryption/decryption Control Words (CWs). Such CWs may be encrypted based on one or more NVPR Program keys or one or more service keys, as described below in conjunction with FIG. 5.

In one embodiment secure content player 345 may include a virtual smart card (VSC) (not shown) to manage the decryption of the received content. For example, in one embodiment the VSC may be configured to manage decryption/encryption keys for use in accessing the received content. Briefly, a VSC includes computer-executable code static data, and the like, that is configured to enable content protection similar to physical smart card approaches. However, unlike the physical smart card approaches, the VSC is configured as software that may be downloaded to enable changes in security solutions to be implemented rapidly (in seconds, minutes, or hours) at relatively low costs. This is in stark contrast to physical smart card approaches that often require new hardware to be generated and distributed. Such physical approaches typically are made available as updates about once or twice a year.

Typical the VSC may include various sub components (not shown) including, secure stores, fingerprinting modules, secure message managers, entitlement manages, key generators, digital copy protection engines, and the like. The VSC may be configured to enable protection of received content in part by managing receipt of and security for various decryption keys, entitlements, or the like. In another embodiment, the VSC may receive the decryption key from another device, over a network, or the like.

Secure content player 345 may also be configured to distinguish between NPVR and broadcast content streams, to determine whether an appropriate entitlement enables access to the content, and employing, if available, an appropriate decryption key(s) to access the content.

Although secure content player 345 is illustrated within applications 342, the invention is not so limited. For example, secure content player 345 may include components external to applications 342. Thus, for example, one embodiment of secure content player 345 may be implemented using a configuration such as the one described in U.S. Pat. No. 7,007,170, issued Feb. 28, 2007, entitled “System, Method, and Apparatus for Securely Providing Content Viewable On a Secure Device,” assigned to Widevine Technologies, Inc., and which is incorporated herein by reference.

### Generalized Operation

FIG. 4 illustrates a flow diagram generally showing one embodiment for a process of generating secure content concurrently for broadcast services and NPVR services using unique keys. Process 400 of FIG. 4 may be implemented with distribution server 10 of FIG. 1.

Process 400 begins, after a start block, at block 402, where content is received. In one embodiment, the content is received as a multicast stream of MPEG data. However, as noted above, the content may also be received in any of a variety of other formats, without departing from the scope of the invention. Processing then proceeds to decision block 404 where a determination is made whether at least a portion of the received content is encrypted. If the received content is not encrypted, processing flows to block 406.

At block 406, the received content is selectively encrypted using at least one CW, as described above. Processing flows next to decision block 408.

If at decision block 404, it is determined that at least a portion is encrypted, processing flows to block 424, where the encryption CWs are received. In one embodiment, the CWs may be received along with the received content. In another embodiment, the CWs are received separate from the received content. In one embodiment, the CWs may be received in at least one ECM. In another embodiment, the CWs may be encrypted using a service key or the like. In any event, at block 424, the CWs are obtained. Processing then continues to decision block 408.

At decision block 408, a determination is made whether to replicate (e.g., copy) the selectively encrypted content into multiple content streams. Such decision may be based, for example, on whether the content is designated to be broadcast to client devices, or to client devices and to be ingested by a VOD server or the like, operating at least in part as an NPVR service. In one embodiment, a policy may be employed that indicates whether a content stream is to be copied based, in part on, its content, an IP address, a content provider, a license, service level agreement, or the like. In any event, if the content stream is not to be copied, processing flows to block 418, where content stream may be further processed for being broadcast to client devices. However, if the content stream is to be copied, processing continues to block 410.

At block 410, the mechanism for copying (or replicating) the content streams may be selected. For example, in one embodiment, the selectively encrypted content may be copied at least once. In one embodiment, the original selectively encrypted content may be employed as one “copy,” while at least one distinct ‘copy’ is made from the original content stream. The copies may be further differentiated based on a network flow path, as described above, by which the content streams are to be communicated towards their destinations.

In an alternative embodiment, the content streams may be replicated employing a process, or mechanism, other than encryption bridge 252 of FIG. 2. For example, in one embodiment, the copying into multiple content streams may be performed by another bridge, an upstream network appliance, or the like, prior to being received by encryption bridge 252, distribution server 110 of FIG. 1, or the like. For example, in one embodiment, the replication or copying of the content stream may be performed external to encryption bridge 252 and provided to separate encryption bridges, similar to encryption bridge 252, at least one for the broadcast content stream, and at least another one for the NPVR content stream.

Processing then may flow along at least two distinct paths, based on a destination of the content streams. Thus, as illustrated, one process flow, blocks 412, 414, and 416, describes one embodiment of additional processing to prepare and transmit one content stream for ingestion by a NPVR service. Another process path, blocks 418, 420, and 422 illustrates one embodiment, of additional processing for a content stream for broadcasting to client devices. Each of these paths may be performed concurrently as illustrated. However, the invention is not so limited. For example, the paths may also be processed sequentially.

In any event, as shown in the figure, at block 412, one copy of the CWs are encrypted using NPVR Program keys for the NPVR destination. Processing continues to block 414, where the encrypted NPVR CWs may be combined into one or more ECMs. In one embodiment, the ECMs may be combined with the selectively encrypted content stream. In one embodiment, the service key may be encrypted based on a recipient's encryption/decryption key and included within an EMM. In one embodiment, a time source may be employed that may define NPVR Programs in terms of distinct durations or boundaries. Each NPVR Program may then have associated with it unique NPVR Program keys that differentiate it from other NPVR Programs and/or VOD assets.

Processing then flows to block 416, where the content stream for this path of process 400 is transmitted to the NPVR/VOD server. In one embodiment, the ECMs and/or EMMs are provided within the content stream. In another embodiment, the ECMs and/or EMMs are provided separate from the provided content stream. Processing then returns to a calling process to perform other actions.

Similarly, at block 418 one copy of the CWs are encrypted using service keys for the broadcast destinations. Processing continues to block 420, where the encrypted broadcast CWs may be combined into one or more ECMs. In one embodiment, the ECMs may be combined with the selectively encrypted content stream. In one embodiment, the service key may be encrypted based on the recipient's encryption/decryption keys and included within one or more EMMs. Processing then flows to block 422, where the content stream for this path of process 400 is transmitted to the client devices. In one embodiment, the content stream is broadcast to the client devices. In one embodiment, the ECMs and/or EMMs are provided within the content stream. In another embodiment, the ECMs and/or EMMs are provided separate from the provided content stream. Processing then returns to a calling process to perform other actions.

Although the above process describes replicating or copying of the content stream into a plurality of content streams, the invention is not so constrained. For example, in one embodiment, one set of CWs may be encrypted with the NPVR Program key, and a copy of the set of CWs may be encrypted with the service key for Broadcasts. The sets of encrypted CWs may then be combined into one or more ECMs, and provided to client devices, and/or to the NPVR/VOD server.

The client devices may then be configured to distinguish between NPVR and broadcast playback of the content stream, and in determining whether an appropriate entitlement enables access to the content.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device for managing access to content over a network, comprising:
a transceiver for receiving and sending information over the network;
a processor in communication with the display and the transceiver; and
a memory in communication with the processor and for use in storing data and machine instructions that causes the processor to perform a plurality of actions, including:
receiving a content stream;
selectively encrypting at least a portion of the content stream with at least one control word (CWs);
if the content stream is to be provided to a client device and a network personal video recorder (NPVR) service, then:
encrypting at least a first copy of the CWs based on a first service key,
encrypting at least a second copy of the CWs based on a NPVR Program key, and
providing a first copy of the selectively encrypted content stream and the first copy of the encrypted CWs to the client device, and
providing a second copy of the selectively encrypted content stream and the second copy of the encrypted CWs to the NPVR service.

2. The network device of claim 1, wherein the service key and the program key are each symmetric encryption/decryption keys.

3. The network device of claim 1, wherein selectively encrypted at least a portion of the content further comprises, selectively encrypting a first portion of the content stream with one CW, and another portion of the content stream with a different CW.

4. The network device of claim 1, where providing the first copy of the encrypted CWs further comprise providing the first copy in an Entitlement Control Message (ECM).

5. The network device of claim 1, wherein the NPVR service is configured to provide the second copy of the CW to the client device.

6. A processor readable medium that includes instructions and data, wherein the execution of the instructions installed on a computing device enables the computer device to perform actions to manage access to a secure content stream, including:
receiving a content stream;
selectively encrypting at least a portion of the content stream with at least one control word (CWs);
encrypting at least a first copy of the CWs based on a first service key;
encrypting at least a second copy of the CWs based on a NPVR Program key;
providing a first copy of the selectively encrypted content stream and the first copy of the encrypted CWs to a client device, wherein the client device is enabled to use the encrypted CWs to decrypt the content stream for play, and
providing a second copy of the selectively encrypted content stream and the second copy of the encrypted CWs to the NPVR service.

7. The processor readable medium of claim 6, wherein providing the service key or the NPVR Program key is performed using at least one of an Entitlement Control Message (ECM) or an Entitlement Management Message (EMM).

8. The processor readable medium of claim 6, wherein selectively encrypted at least a portion of the content further comprises, selectively encrypting a first portion of the content stream with one CW, and another portion of the content stream with a different CW.

9. The processor readable medium of claim 6, wherein the computer device to perform actions, including encrypting the service key using an encryption key.

10. The processor readable medium of claim 6, wherein the computer device to perform actions, including:
encrypting a least a third copy of the CWs based on a second NPVR Program key;
providing a third copy of the selectively encrypted content stream and the third copy of the encrypted CWs to another NPVR service.

11. The processor readable medium of claim 6, wherein the service key or the NPVR Program key is encrypted based on a client device's encryption/decryption key.

12. A system for use managing access to a content stream, comprising:
an encryption bridge that is configured and arranged to receive the content stream and to perform actions, including:
if the content stream is unencrypted, selectively encrypting the content stream with at least one control word (CWs);
encrypting at least a first copy of the CWs based on a first service key,
encrypting at least a second copy of the CWs based on a NPVR Program key;
providing a first copy of the selectively encrypted content stream and the first copy of the encrypted CWs to a client device, and
providing a second copy of the selectively encrypted content stream and the second copy of the encrypted CWs to the NPVR service; and
the NPVR service that is configured to perform actions, including:
receiving the copy of the selectively encrypted content stream and the second copy of the encrypted CWs;
receiving a request for the copy of the selectively encrypted content stream;
enabling access to the second copy of the encrypted CW based in part on a purchase; and
providing the second copy of the selectively encrypted content stream and the second copy of the encrypted CWs to a purchaser.

13. The system of claim 12, further comprising:
the client device that is configured to perform actions, including:
receiving the first copy of the selectively encrypted content stream and the first copy of the encrypted CWs;
employing a virtual smart card (VSC) to employ the first copy of the encrypted CWs to decrypt the selectively encrypted content stream; and
playing the decrypted content stream.

14. The system of claim 12, wherein:
providing the first copy of the selectively encrypted content stream and the first copy of the encrypted CWs further comprise providing the content stream and the encrypted CWs using different communication mechanisms.

15. The system of claim 12, wherein the NPVR Program key is encrypted using an encryption key associated with the purchaser.

16. A method of managing access to content securely, comprising:
selectively encrypting a content stream with at least one control word (CWs);
encrypting at least a first copy of the CWs using a service key;
encrypting at least a second copy of the CWs using a NPVR Program key;
providing a first copy of the selectively encrypted content stream and the first copy of the encrypted CWs to a client device, and
providing a second copy of the selectively encrypted content stream and the second copy of the encrypted CWs to the NPVR service.

17. The method of claim 16, wherein selectively encrypting the content stream further comprises employing at least two different CWs, wherein a first portion of the content stream is encrypted using a first CW, and another portion is encrypted using another CW.

18. The method of claim 16, wherein providing a first copy of the selectively encrypted content stream and the first copy of the encrypted CWs to a client device further comprising employing a transmission broadcast mechanism.

19. The method of claim 16, wherein the client device is configured to provide a request to the NPVR service to access the second copy of the selectively encrypted content stream.

20. A modulated data signal configured to include program instructions for performing the method of claim 16.
